(19) United States
(12) Patent Application Publication
(10) Pub. No.: US 2007/0158139 A1
(43) Pub. Date: Jul. 12, 2007

(54) Compact Gerotor Descent Unit

(75) Inventors: Jon K. Moon, Edina, MN (US); Thomas J. McPeak, Shakopee, MN (US)

Correspondence Address: DEVICIX, LLC, 207 CHESTNUT ST., #225, CHASKA, MN, 55318-2901, US

(73) Assignee: DEVICIX, LLC, Chaska, MN (US)

(21) Appl. No.: 11/623,055

(22) Filed: Jan. 12, 2007

Related U.S. Application Data
(60) Provisional application No. 60/758,370, filed on Jan. 12, 2006.

(51) Int. Cl. A62B 1/12

(52) U.S. Cl. 182/238

(57) ABSTRACT

The invention enables controlled descent from a height to the ground. A gerotor compressor causes fluid to flow through a restriction which limits the rotational speed of a spool attached to the compressor shaft. As the spool rotates a line or cord wound on the spool is controllably released allowing a person or object attached to the compressor to descend at a safe rate.

### CROSS-REFERENCE TO RELATED APPLICATIONS

This application claims the benefit of the filing date of copending provisional application U.S. Ser. No. 60/758,370, filed Jan. 12, 2006, entitled “COMPACT GEROTOR DESCENT UNIT”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to devices and methods for controlling descent. More specifically, the invention is a personal lowering device to safely reach ground from a height.

2. Description of the Related Art

The opportunity exists to replace 1970's era personal lowering equipment with a new design incorporating improved materials and computer-aided design. Limitations of the existing device in terms of ease-of-use, descent rate control, exposed components and heat dissipation are addressed. The current personal lowering device (PLD) is intended to allow aircrew a controlled descent from heights up to 140 ft. It consists of tubular nylon strap wrapped as loops inside a flat cloth bag approximately 2 ft by 2 ft. The bag may be attached to a parachute and worn between the user's back and the parachute. Attachment points and the descent mechanism cross over the shoulder and are attached to a strap on the chest for access when needed. The free end of the nylon strap terminates in a clip that can be passed around a tree limb and then clipped to a ring approximately 2 ft further up the strap. A buckle with a sliding member pinches the nylon strap to provide friction against the strap to control descent. During descent the aircrew must apply constant tension to the pinch member with a separate strap to adjust their speed: with no manual tension on the strap the user falls freely.

A number of the pumps incorporate gerotor stages as a means of supplying high volumes of low pressure hydraulic fluid to quickly advance cylinders out to the load as well as to supercharge lower volume, high-pressure piston pumps. Examples of fluid handling equipment with gerotor stages are models PE17 and PA17 at http://www.powerteam.com//catalog/pdf/PT501pgs42-43.pdf; and PA6 at http://www.powerteam.com//catalog/pdf/PT501pgs26-27.pdf. Designs related to linkages and fluid controls are described in U.S. Pat. Nos. 5,224,254 and 5,419,027.

### BRIEF SUMMARY OF THE INVENTION

The present invention is a “Personal Descent Unit” that enables a person to perform a controlled descent at will, such as from a building to the ground. It may be used for emergency egress, or to escape from a tree or height. A gerotor compressor captures the heat produced by the descent as well as controlling the release of a support line. The result is a compact device comprising a single unit that resembles a consumer product and can be easily operated without prior instruction. Operator controls can be operable even by a user impaired by injury or encumbered with equipment. Improved materials and computer-aided optimization of load-bearing structures can result in a device that is light and small. All mechanisms and the support line would be contained in a single housing that provides protection against contamination and deterioration. Additionally, the housing would protect the operator from mechanisms and heat. The descent rate would be controlled independent of loads. The present invention is envisioned as a single-use device that could see wide applicability in consumer and rescue applications.

The invention may be configured as a self-contained device with no exposed components other than attachment points. It will resemble a “consumer” device and be suitable for applications beyond the military for purposes of emergency building egress or descent for climbers. Particular features include a fixed descent rate regardless of load (with the option to pre-set various descent rates) and no abrasion of the support line.

### OBJECTS OF THE INVENTION

To provide controlled descent with a small device that is useable without prior experience.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an assembly of the present invention seen through the housing;

FIG. 2 illustrates the invention from the reverse side of FIG. 1;

FIG. 3 is a simplified schematic of a gerotor compressor.

### DETAILED DESCRIPTION OF THE INVENTION

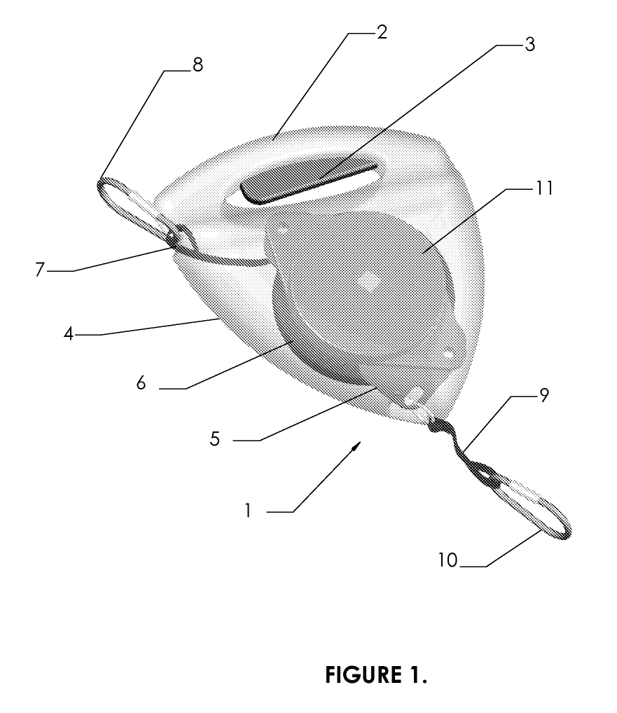

The present invention is best understood in relation to FIGS. 1 through 3 of the drawings, like numerals being used for like elements of the drawings.

A personal descent embodiment of the present invention 1 is shown in FIG. 1. It consists of a gerotor compressor 11 attached to a structural frame 5 capable of supporting the dynamic load of a person or object (i.e. preferably several times the static weight). Also attached to the frame 5 are a static support line 9 and clip 10, and the housing 4. Incorporated in the housing is a handle 2 that contains a trigger 3 which initiates and allows the operator to control descent.

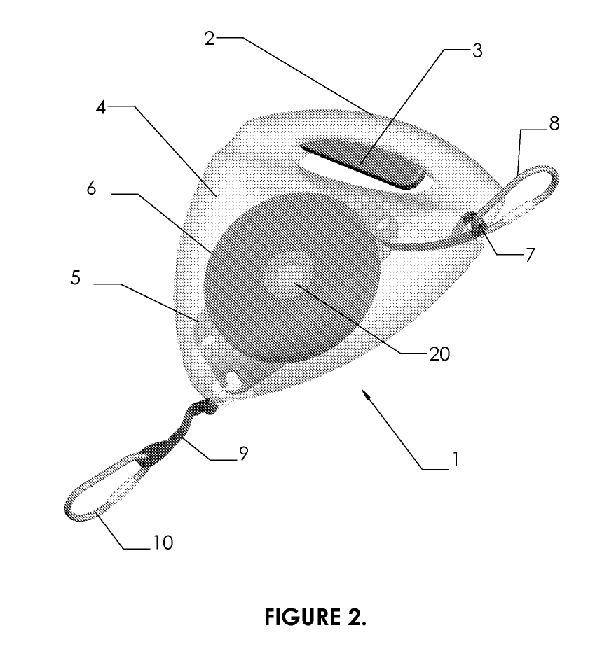

Referring to FIG. 2 it is easier to see the dynamic support line wound on a spool 6 that is attached to or part of the shaft 20 attached to the inner gear (33, see below) of the gerotor compressor 11. A portion of dynamic line 7 forms an attachment to a clip 8.

In operation, the clip 10 on the static line 9 is attached to the person or object to be lowered. Commonly, the person is wearing a strap or harness with a ventral ring located above the center of mass. The clip 10 is snapped onto the ring allowing the weight of the person to be born while allowing the person to remain upright and keep the present in view and within reach. Next, the dynamic support line 7 is attached to an object capable of supporting the dynamic weight of the person using the invention. This may easily be achieved by passing the first portion of the support line 7 over a railing or limb of a tree and attaching the clip 8 back onto the support line 7. Once the attachments are tested for load the user is ready to begin descent.

The spool 6 supporting the dynamic support line 7 is locked relative to the gerotor compressor 11 and frame 5 when the trigger 3 is released. The user initiates descent by grasping and pulling the trigger 3 into handle 2. This releases the lock (not shown) and allows the spool 6 to rotate gerotor shaft 20. A working fluid is pumped by the gerotor compressor to control descent. The trigger may be set to provide a fixed rate of descent or the user control the rate of descent with the position of the trigger. Releasing the trigger slows and/or stops descent, which can be resumed when the trigger is again depressed.

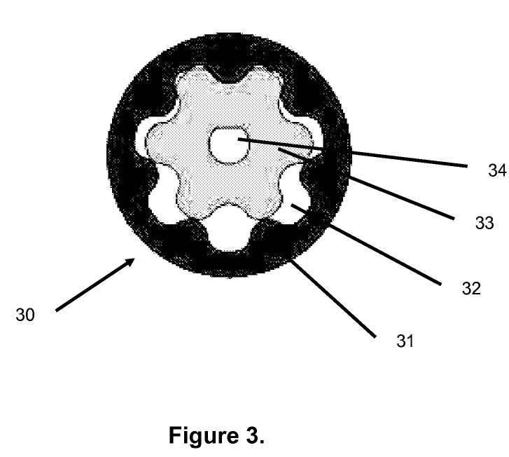

The major components of a gerotor device 30 are illustrated in FIG. 3. The inner gear 33 contains 1 less tooth than the outer ring gear 31. As the teeth of inner gear 33 and outer gear 31 are rotated, the volume 32 between the gears is varied causing a working fluid to be compressed enabling the gerotor 1 to act as a pump. Alternatively, a fluid can be forced into the volume 32 between the inner 33 and outer 31 gears causing the gerotor to function as a motor (turning fluid pressure into mechanical rotation).

Outer ring gear 31 forms or is attached to a housing (not shown) of the gerotor 30 compressor. The housing typically includes flanges with holes or similar structures to facilitate mounting to a frame or structure (not shown).

Gerotor devices are simple in design, reliable, compact and capable of high pressure. Further description of gerotor function are available in various references, including [http://ulisse.polito.it/matdid/1ing_mec_P3850_TO_{—}0/OPES/pdf/shifk2002.pdf]. Additional benefits include no need for lubrication, tolerance to extreme environments, low inherent noise and limited pulse ripple. The size of a gerotor pump or compressor can be scaled continuously in both diameter and length to achieve desired performance characteristics. In addition, multiple gerotor stages may be stacked to boost total pressure or capacity in a restricted form factor. Gerotor compressors are compatible with almost any working fluid, including air and biodegradable compounds.

Torque developed by the weight of the user unwinding line 7 from the spool 6 is used to rotate the inner gear 33 of the gerotor and pressurize a fluid. The pressurized fluid is then forced over a fluid flow resistance, such as a relief valve, converting the potential energy of the load into heat. A descent rate suitable for military applications or experienced users is 2 to 3 ft/s (0.61 to 0.92 m/s). For inexperienced users descent should be no faster than 2 ft/s (0.61 m/s).

The gerotor compressor 11 controls descent by delivering torque to the support line spool 6 as needed to maintain a constant speed. There are four means to control the torque obtained from a gerotor: relative rotational speed, offset between the inner and outer ring rotational axes, fluid inlet area, and flow resistance between the outlet and reservoir or exhaust. A planetary gear set (not shown) will provide optimal rotational speed at the gerotor for the required spool size, load range and descent rate.

Approximately 70 kW of work is performed by controlling descent of a 160 kg load, such as a person, through a distance of 43 m. At a maximum descent rate of 1 m/s the traverse is completed in less than 50 s. Currently available devices deliver this heat to the support line, which degrades its load-carrying capability, as well as being difficult to control. In the present invention heat may either be stored in the gerotor mechanism and working fluid or else expelled as heated fluid or vapor. The support line and personnel are easily protected from this heat.

Listed below are characteristics and features that may be attained with the present invention as suitable for individuals:

Compact, dimensions of “flight suit pocket”

Weight, <3 kg

Load capacity of 100 to 350 lb (34 to 160 kg);

Safety factor of at least 2×

Failsafe to overrun condition

One-time use

Manual trigger or load-based trigger

Descend at least 140 ft (43 m)

Operating temperature range of −30 to +45° C.

Easily disengaged after use or camouflaged

May capture released potential energy for other purpose and to reduce IR visibility

Operable with one hand or while injured or encumbered

No toxic compounds or components

Descent rate may be varied by length of support line deployed

When heat is stored in the unit with a reservoir of incompressible liquid as the working fluid there must be sufficient heat capacity and thermal insulation to protect the operator and support lines from excess temperature until the descent is complete. If the device is one-time-use the device can melt later. This configuration is more reliable and quieter, but requires a substantial mass of fluid, more thermal insulation and pump components able to withstand higher temperature. Therefore, the final device will be relatively heavier and larger. In addition, the storage life and operating temperature range of the liquid may need to be considered.

Alternatively, the working fluid can be expelled from the device as it absorbs heat. There are two means to release heat in the working fluid. If the gerotor compressor 11 is operated on air then heat is easily exhausted because the fluid is not recirculated. This design will be lighter and smaller. However, the gerotor must be built to tighter tolerances (resulting in higher cost) and it will be noisy (some muffling may be possible). The third configuration allows an incompressible fluid to gradually escape as vapor through a relief valve. This design can be adjusted to balance requirements of size, weight and noise.

In any of the above scenarios, the addition of a fan blade or impeller can increase the amount of heat transferred from the device to the surroundings. A natural extension of the rotational motion that is used to operate this device would include a fan mechanism in order to optimize this heat transfer.

The dynamic support line 7 must be released from the lowering device 1 at maximum rates between 0.6 and 1 m/s. Control may provided either by the spool rotation rate or by having the line pass over a lever arm that responds to load or line speed to adjust one or more of the parameters of the gerotor compressor 11.

Kevlar tape meeting Mil Spec MIL-T-87130 may be used as the support lines and be stored on the spool 6. For example, 43 m of 272 kg tensile Kevlar could be stored on a 2-cm wide spool with an inner diameter of 5 cm and outer diameter of 13 cm. This tensile rating provides a 2× safety factor at a load requirement of 160 kg. A greater safety factor relative to dynamic loads could be accommodated by larger tape (width and/or thickness). Kevlar has good resistance to heat but should be protected from self-abrasion.

The housing 4 protects components during storage and operation and protects the operator from moving parts and heat. The housing could be injection molded of structural foam that would provide substantial insulation properties and protect the user from heat. The interface between the user and the device housing is intuitive (minimizing effort of training and improving the ability of the user to properly operate the device while under stress).

The frame 5 mounts the support line spool 6 and gerotor 11 circuit. It transmits load from the spool to the user attached by the static clip 10.

The trigger 3 allows a user to initiate descent. The requirements may also be extended to accommodate an injured operator, to halt/resume descent and to change descent rate. Design concepts based consumer products (for example, the handle 2 in FIG. 1) to isolate the user from high temperatures on user interface surfaces and to minimize inadvertent control activation.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

The present invention is superior to many escape device, such as ladders and ropes, that are sold to consumers. Additional applications include fire, rescue and industrial uses. Military applications are also foreseen, such as descent of a parachutist entrapped in a tree, insertion of special forces from a hovering aircraft and rapid egress from structures and tall vehicles.

What is claimed is:

1. An controlled descent device comprising:
a frame;
a gerotor compressor comprising an outer gear ring mounted on the frame, an inner ring attached to a rotatable shaft, and an inlet and outlet for a working fluid;
a first clip attached to an end of the frame;
a spool attached to the shaft;
a flexible, load-bearing line wound on the spool;
a second clip attached to the free end of the line;
a fluid circuit incorporating the gerotor compressor and a flow restriction in communication with the outlet of the gerotor compressor wherein the flow rate of the fluid flowing past the flow restriction from the outlet of the gerotor compressor controls the rotational rate of the spool.

2. The descent device of claim 1 wherein the fluid circuit is closed from the outlet to the inlet of the gerotor compressor with the flow restriction interposed between the inlet and outlet.

3. The descent device of claim 1 further comprising a fluid reservoir in communication with the inlet of the gerotor compressor.

4. The descent device of claim 1 wherein the flow restriction may be adjusted by a manual control

5. A method of controlling descent comprising the steps of:
providing a controlled descent device comprising a gerotor compressor attached to a frame, a first clip extending from the frame, and a second clip attached to a flexible line wound onto a spool, wherein the spool is attached to a rotatable shaft of the compressor;
attaching the first clip to an object to be lowered;
attaching the second clip to a fixed object;
regulating the flow of a fluid through the compressor to control the rotation rate of the spool.

6. The method of claim 5 further comprising the step of depressing a trigger to regulate the fluid flow.
